(19) United States
(12) Patent Application Publication
(10) Pub. No.: US 2023/0259879 A1
(43) Pub. Date: Aug. 17, 2023

(54) SYSTEMS AND METHODS FOR CONTROLLING THE MERCHANDISE BEING DELIVERED TO DISTRIBUTION CENTERS

(71) Applicant: Walmart Apollo, LLC, Bentonville, AR (US)

(72) Inventors: Willie Montgomery, III, Rogers, AR (US); Jeremy Shoblom, Bentonville, AR (US); Zhuofei Li, Bentonville, AR (US); Mark A. Krieger, Kansas City, MO (US); Rohini Thota, Bentonville, AR (US); Robert D. Martinez, Bentonville, AR (US); Adam J. Cairns, Bentonville, AR (US); Ting Li, Bentonville, AR (US)

(21) Appl. No.: 18/011,787

(22) PCT Filed: Jun. 22, 2021
(86) PCT No.: PCT/US2021/038467

§ 371 Date: Dec. 20, 2022

Related U.S. Application Data
(60) Provisional application No. 63/042,649, filed on Jun. 23, 2020.

(51) Int. Cl. G06Q 10/087; G06Q 30/0601

(52) U.S. Cl. CPC G06Q 10/087; G06Q 30/0633

(57) ABSTRACT

There are provided systems and methods relating to regulating merchandise received at distribution centers. In one form, the system includes: a distribution center for storing various types of merchandise, and purchase orders for projected incoming merchandise to be delivered on projected delivery dates from vendors to the distribution center. The system also includes a control circuit configured to: receive a merchandise capacity limit for one or more storage areas for a future target date; determine a projected amount of merchandise present at the storage area(s) for the future target date; compare the projected amount of merchandise to the merchandise capacity limit; if the projected amount of merchandise does not exceed the limit, transmit the purchase orders to the corresponding vendors; and if the projected amount of merchandise exceeds the limit, apply prioritization criteria to adjust some of the purchase orders and defer the projected delivery dates for those purchase orders.

### CROSS-REFERENCE TO RELATED APPLICATION

This application claims the benefit of U.S. Provisional Application No. 63/042,649, filed Jun. 23, 2020, which is incorporated by reference in its entirety herein.

### TECHNICAL FIELD

This invention relates generally to incoming shipments of merchandise to distribution centers, and more particularly, to regulating the amount of merchandise arriving at distribution centers.

### BACKGROUND

In the retail setting, merchandise distribution centers generally store and maintain a wide variety of types of merchandise items in storage areas. Many of these merchandise distribution centers are constantly shipping out merchandise to retail stores and/or customers, while simultaneously receiving inbound merchandise from vendors. These merchandise distribution centers generally include one or more loading docks and receiving areas for receiving delivery vehicles with incoming merchandise for unloading and storage at the merchandise distribution center.

There is a need for an approach to regulate the inbound shipments of merchandise to the distribution center. If not managed carefully, there is a potential for the incoming shipments of merchandise to exceed the capacity of the merchandise distribution (whether that capacity is based on labor capacity, physical space availability, and/or other factors). Therefore, a need exists to regulate the inbound shipments so that the incoming merchandise, plus the amount of merchandise already present in storage area(s), does not exceed the capacity of those storage area(s). Accordingly, a need exists to control incoming shipments of merchandise, such as by developing an approach to prioritize the purchase orders for incoming merchandise.

Further, this control of incoming shipments requires a careful evaluation and weighing of competing factors. More specifically, with the finite capacity of a distribution center, a retailer must use data and algorithms to ensure that orders with the most critical products for customers receive the available capacity. For example, orders of high priority vendors or high priority merchandise items (such as, for instance, merchandise with limited shelf life) must be given appropriate weight so they can be handled in an expeditious manner. Ultimately, an end goal of this expeditious handling of the most critical products is to increase customer satisfaction, which is a core concern of all retailers.

### BRIEF DESCRIPTION OF THE DRAWINGS

Disclosed herein are embodiments of systems, apparatuses and methods for regulating the amount of merchandise arriving at distribution centers. This description includes drawings, wherein:

FIG. 1 is a schematic diagram in accordance with some embodiments;

FIG. 2 is a block diagram in accordance with some embodiments;

FIG. 3 is a flow diagram in accordance with some embodiments;

FIG. 4 is a flow diagram in accordance with some embodiments;

FIG. 5 is a flow diagram in accordance with some embodiments;

FIG. 6 is a flow diagram in accordance with some embodiments; and

FIG. 7 is a flow diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one form,” “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification do not all refer to the same embodiment.

Generally speaking, pursuant to various embodiments, systems, apparatuses and methods are provided herein for regulating the amount of merchandise arriving at distribution centers. In one form, the system includes: a merchandise distribution center configured for storage of a plurality of types of merchandise items in a plurality of storage areas, the merchandise distribution center comprising one or more receiving areas configured to receive delivery vehicles with incoming merchandise for unloading and storage at the merchandise distribution center; the plurality of types of merchandise items comprising a first set of high priority types of merchandise items and a second set of low priority types of merchandise items; and a plurality of purchase orders for projected incoming merchandise to be delivered in future shipments from a plurality of vendors supplying shipments of the incoming merchandise to the merchandise distribution center, the plurality of vendors comprising a first set of high priority vendors and a second set of low priority vendors; each purchase order including one or more types of merchandise items with a projected delivery date at the merchandise distribution center; The system also includes a control circuit configured to: receive a merchandise capacity limit for one or more of the storage areas for a future target date at the merchandise distribution center (whether that capacity is based on labor capacity, physical space availability, and/or other factors); determine a projected amount of merchandise present at the one or more storage areas for the future target date based, at least in part, on the plurality of purchase orders; compare the projected amount of merchandise to the merchandise capacity limit to determine an insufficient capacity situation for that future target date; if the projected amount of merchandise does not exceed the merchandise capacity limit, such that no insufficient capacity situation exists for the future target date: transmit the plurality of purchase orders to the corresponding vendors; if the projected amount of merchandise exceeds the merchandise capacity limit, such that an insufficient capacity situation exists for the future target date: determine a first group of purchase orders corresponding to the high priority set of vendors; determine a second group of purchase orders corresponding to the high priority types of merchandise items; adjust the projected delivery dates at the merchandise distribution center for at least some of the purchase orders not in the first and second groups to one or more deferred dates after the future target date; and transmit the purchase orders in the first and second groups to the corresponding vendors.

In some implementations, in the system, the first set of high priority types of merchandise items comprises at least one of meat, produce, and other types of perishable merchandise items. In some implementations, if the projected amount of merchandise exceeds the merchandise capacity limit, such that an insufficient capacity situation exists on the future target date, the control circuit is configured to: determine a third group of purchase orders corresponding to promotional types of merchandise items; leave unchanged the projected delivery dates at the merchandise distribution center for the third group of purchase orders; and transmit the purchase orders in the third group to the corresponding vendors. In some implementations, if the projected amount of merchandise exceeds the merchandise capacity limit, such that an insufficient capacity situation exists, the control circuit is configured to: determine a fourth group of purchase orders corresponding to types of merchandise items at the merchandise distribution center with on hand amounts below a predetermined minimum threshold; leave unchanged the projected delivery dates at the merchandise distribution center for the fourth group of purchase orders; and transmit the purchase orders in the fourth group to the corresponding vendors. In some implementations, if the projected amount of merchandise exceeds the merchandise capacity limit, such that an insufficient capacity situation exists, the control circuit is configured to: determine a fifth group of high priority purchase orders, as determined by predetermined prioritization rules; leave unchanged the projected delivery dates at the merchandise distribution center for the fifth group of purchase orders; and transmit the purchase orders in the fifth group to the corresponding vendors. In some implementations, in the system, the prioritization rules are based on one or more of forecast sales, lost sales, forecast margin, lost margin, and forecast days on hand of merchandise items at the merchandise distribution center. In some implementations, the prioritization rules are based on a priority score calculation for each purchase order in the fifth group of purchase orders, the priority score calculation based on combining a priority value for each of: total forecast sales for the merchandise items in the purchase order, total lost sales for the merchandise items in the purchase order, total forecast margins for the merchandise items in the purchase order, total lost margins for the merchandise items in the purchase order, and a forecast days on hand for the merchandise item in the purchase order with the minimum forecast days on hand. In some implementations, in the system, if the projected amount of merchandise exceeds the merchandise capacity limit, such that an insufficient capacity situation exists, the control circuit is configured to: receive delivery load information corresponding to a merchandise load to be delivered by a delivery vehicle, each delivery load including merchandise in one or more purchase orders; determine a high priority delivery load that includes a purchase order that has been prioritized as a high priority purchase order with a projected delivery date that is not to be deferred; identify other purchase orders in the high priority delivery load; and leave unchanged the projected delivery dates of the other purchase orders in the high priority delivery load. In some implementations, if the projected amount of merchandise exceeds the merchandise capacity limit, such that an insufficient capacity situation exists, the control circuit is configured to: determine a low priority delivery load where none of the purchase orders in the load have been prioritized as a high priority purchase order such that the projected delivery dates of all of the purchase orders may be deferred; and adjust the projected delivery dates of all of the purchase orders to the same projected delivery date. In some implementations, in the system, each projected delivery date is determined by lead time required for each vendor and comprises order processing time and delivery transit time to the merchandise distribution center.

In another form, there is provided a method for regulating the amount of merchandise received at merchandise distribution centers, the method comprising: storing a plurality of types of merchandise items in a plurality of storage areas at a merchandise distribution center, the merchandise distribution center comprising one or more receiving areas configured to receive delivery vehicles with incoming merchandise for unloading and storage at the merchandise distribution center; the plurality of types of merchandise items comprising a first set of high priority types of merchandise items and a second set of low priority types of merchandise items; receiving shipments of the incoming merchandise to the merchandise distribution center from a plurality of vendors, the plurality of vendors comprising a first set of high priority vendors and a second set of low priority vendors; creating a plurality of purchase orders for projected incoming merchandise to be delivered in future shipments from the plurality of vendors, each purchase order including one or more types of merchandise items with a projected delivery date at the merchandise distribution center; and by a control circuit: receiving a merchandise capacity limit for one or more of the storage areas for a future target date at the merchandise distribution center (whether that capacity is based on labor capacity, physical space availability, and/or other factors); determining a projected amount of merchandise present at the one or more storage areas for the future target date based, at least in part, on the plurality of purchase orders; comparing the projected amount of merchandise to the merchandise capacity limit to determine an insufficient capacity situation for that future target date; if the projected amount of merchandise does not exceed the merchandise capacity limit, such that no insufficient capacity situation exists for the future target date: transmitting the plurality of purchase orders to the corresponding vendors; and if the projected amount of merchandise exceeds the merchandise capacity limit, such that an insufficient capacity situation exists for the future target date: determining a first group of purchase orders corresponding to the high priority set of vendors; determining a second group of purchase orders corresponding to the high priority types of merchandise items; adjusting the projected delivery dates at the merchandise distribution center for at least some of the purchase orders not in the first and second groups to one or more deferred dates after the future target date; and transmitting the purchase orders in the first and second groups to the corresponding vendors.

As an overview, this disclosure is directed generally to approaches for prioritizing purchase orders for incoming shipments to a merchandise distribution center. Often, it has been found that there may be a high variability of inbound merchandise case volume to a distribution center. As a result, there may be continual merchandise capacity breaches, which, in turn, may lead to employee overtime, delivery vehicles waiting to be unloaded and high unloading times, and an increased chance that individuals may become injured or make mistakes. It is therefore desirable to prioritize purchase orders and push projected delivery dates back, if needed, based on capacity and order of importance of the incoming merchandise, to decrease the volatility of the merchandise cases that are being received on a daily basis

One goal therefore is to minimize the amount of cases that are exceeding the inbound case capacity in an effort to enable better labor planning and case handling. If the number of cases inbound for a merchandise distribution center exceeds a distribution center's case capacity, purchase order prioritization logic is intended to take the lowest priority purchase orders and make an adjustment to their projected delivery dates to avoid capacity breaches. If the capacity of the merchandise distribution center is not exceeded, however, then there is no need to make any adjustments to the purchase orders.

In this regard, it should be understood that “capacity” and the “merchandise capacity limit” may be determined based on various criteria. In one preferred form, it is generally contemplated that “capacity” and the “merchandise capacity limit” refer to the labor capacity, which is based on the maximum number of merchandise cases that can be handled by individuals at a distribution center. In other words, the limitation on available “capacity” is constrained by the available labor. In other forms, however, “capacity” and “merchandise capacity limit” may be a constraint established by other factors, such as, for example, the amount of physical storage space available for the storage of merchandise (not already occupied by merchandise) at a distribution center (the physical storage capacity). In still other forms, it is contemplated that the “capacity” and the “merchandise capacity limit” may be a constraint based on a combination of factors.

The approaches described herein apply prioritization logic to determine which purchase orders have projected delivery dates that can be adjusted (deferred/pushed back to a later date). For example, these approaches may prevent prioritization of purchase orders that include items on them that are not shown in the inventory of the merchandise distribution center or that include items on them that are on promotion. So, if an exceeding capacity situation is determined, the system will rank each of the purchase orders based upon prioritization rules, which might also include, for example, certain factors relating to each type of merchandise item, such as, without limitation, forecasted sales, lost sales, forecasted profit, lost profit, and/or days on hand of the merchandise at the distribution center.

In addition, when a purchase order is prioritized, it may affect other purchase orders. For example, when a purchase order is prioritized, it may result in the necessary prioritization of the entire load of an incoming shipment (such as on the trailer of a delivery vehicle). An adjustment to an individual purchase order's projected delivery date could also result in adjustments to other projected delivery dates for other purchase orders of merchandise that may be occupying the same trailer. The projected delivery date on a purchase order is preferably adjusted before the purchase order is processed and before the corresponding supplier/vendor sees the purchase order.

This disclosure addresses a system 100 for regulating the amount of merchandise received at merchandise distribution centers. The system 100 involves scheduling inbound shipments to a merchandise distribution center by prioritizing purchase orders in order to avoid oversupply to a merchandise distribution center on a particular future date. This scheduling generally involves adjusting the projected delivery dates of purchase orders based on various prioritization rules. It is desirable to minimize (or eliminate) the amount of merchandise cases that are exceeding inbound case capacity so as to enable better labor planning, case handling, and inbound procedures.

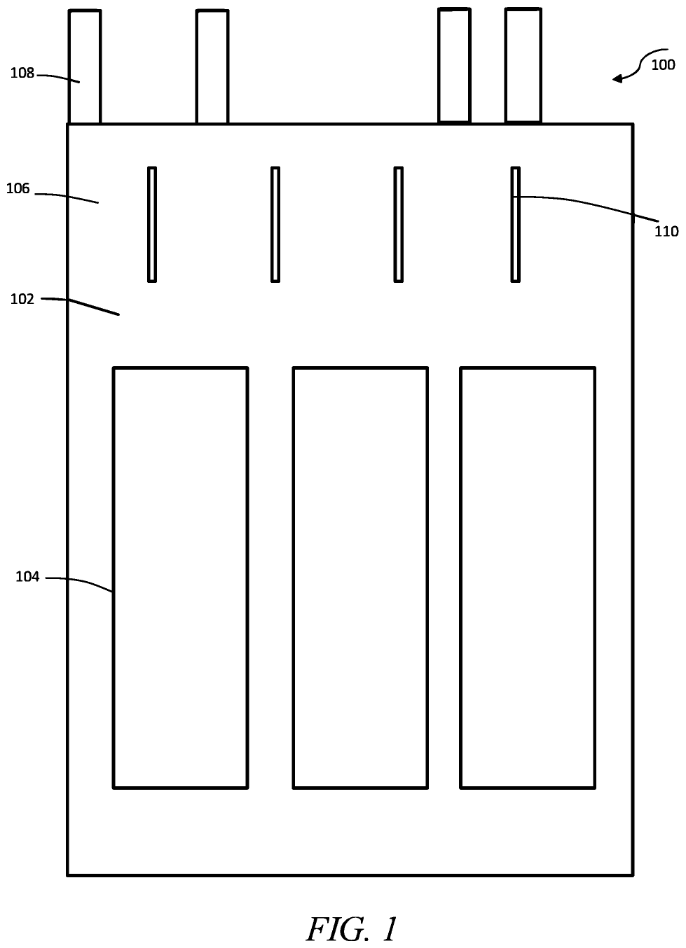

Referring to FIG. 1, there is shown a schematic diagram of a merchandise distribution center 102 or warehouse. The merchandise distribution center 102 is configured for storage of various types of merchandise items in storage areas 104. In this example, the merchandise distribution center 102 includes three storage areas 104, or chambers. It is also contemplated that the merchandise distribution center 102 includes one or more receiving areas 106 (such as loading docks) configured to receive delivery vehicles 108 with incoming merchandise for unloading and storage at the merchandise distribution center 102.

In one form, the merchandise distribution center 102 may be operated by a retailer for the purpose of holding merchandise that may, in turn, be transported to multiple stores. As stated, the merchandise distribution center 102 may include receiving areas/loading docks 106 for receiving incoming delivery vehicles with trailers 108 transporting shipments of merchandise such as from vendors/suppliers, and the loading docks 106 may also be used for outgoing shipments to stores. In this example, multiple storage areas 104 may be arranged throughout the merchandise distribution center 102 for the storage of merchandise. Further, in one example, conveyors 110 may be arranged throughout the merchandise distribution center 102, including near the loading docks 106, to facilitate movement of merchandise about the merchandise distribution center 102. As should be evident, a variety of possible types and arrangements of merchandise distribution centers (including warehouses) is contemplated.

Various types of merchandise may be allocated to specific storage areas 104 in the merchandise distribution center 102. It is also contemplated that the system 100 (and part or all of the distribution center 102) may be applied to a specific category of merchandise, such as, without limitation, grocery merchandise. Further, in one form, it is contemplated that the types of merchandise items may be separated into a first set of high priority types of merchandise items and a second set of low priority types of merchandise items. For example, assuming the general category of grocery merchandise, meat and produce may be assigned to the high priority set, while dry grocery and other grocery may be assigned to the low priority set. In this example, meat and produce may be assigned to the high priority set due to perishability or other concerns.

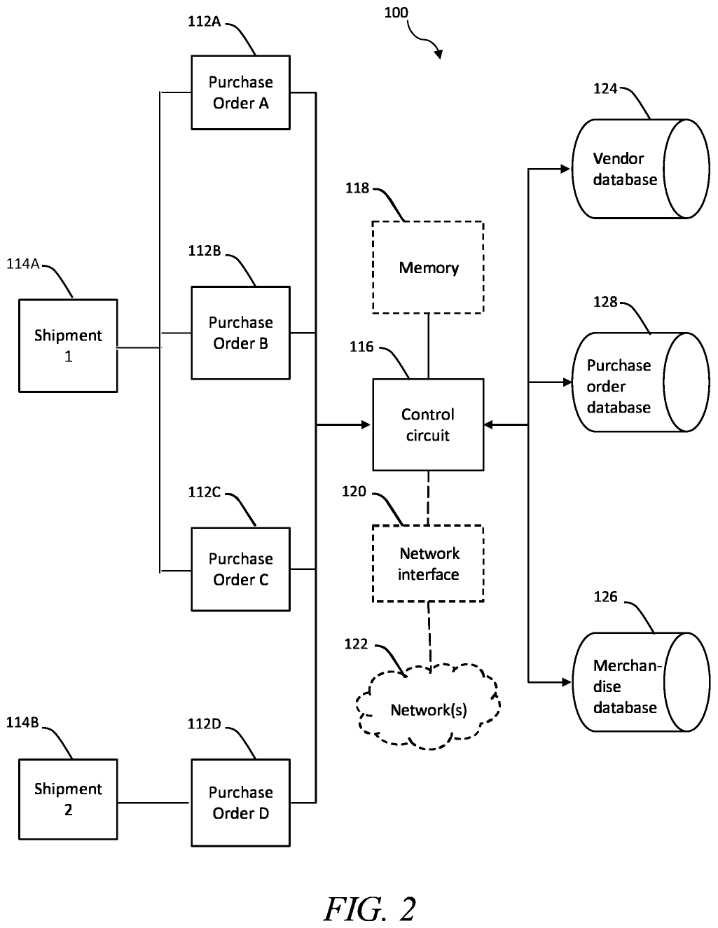

Referring to FIG. 2, the system 100 includes purchase orders 112 for projected incoming merchandise to be delivered in future shipments from vendors supplying shipments of the incoming merchandise to the merchandise distribution center 102. As can be seen, in this particular example, there are four purchase orders: purchase order A (112A), purchase order B (112B), purchase order C (112C), and purchase order D (112D). It should be understood that various numbers of purchase orders 112 may be involved, and it is generally contemplated that numerous purchase orders 112 may be involved. Each purchase order 112 may include one or more types of merchandise items with a projected delivery date at the merchandise distribution center 102. Further, it is also contemplated that the vendors may be separated into a first set of high priority vendors and a second set of low priority vendors. The vendors may be assigned high priority or low priority based on any of various factors, such as length and/or nature of the relationship with the vendor, reputation of the vendor, credit rating and/or financial history of the vendor, nature of the vendor's merchandise, etc.

In this disclosure, the phrase “projected delivery date” generally refers to the last date that delivery of a shipment should be made to a merchandise distribution center 102. In other words, it refers to the latest delivery date or the must-arrive-by-date at the distribution center 102. The purchase orders each generally include an order date and a must-arrive-by-date, and some of these must-arrive-by-dates may be adjusted prior to a purchase order being transmitted to (or seen by) the vendor/supplier, as addressed below. It is generally contemplated that there will be a certain amount of time between the order date and the projected delivery date to take into account order processing and delivery transit. So, the projected delivery date may be determined, at least in part, by the lead time required for each vendor and may include the order processing time and delivery transit time to the merchandise distribution center 102.

In addition, as shown in FIG. 2, the purchase orders 112 may be associated with specific shipments 114 (or delivery loads) transported on trailers of delivery vehicles 108. Some of the purchase orders 112 may include merchandise that is in the same shipment 114. In the example shown in FIG. 2, purchase orders A, B, and C (112A, 112B, 112C) include merchandise that is part of shipment 1 (114A), while purchase order D (112D) includes merchandise that is part of shipment 2 (114B). As described further below, the handling of the projected delivery date of one purchase order (such as, for example, purchase order A) may require similar handling of the projected delivery dates of the other purchase orders (purchase orders B and C) that are part of the same shipment (shipment 1).

The system 100 also includes a control circuit 116 that governs the operation of the system 100. As described herein, the language “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 116 may be configured (for example, by using corresponding programming stored in a memory as will be well understood by those skilled in the art) to carry out one or more of the steps, actions, and/or functions described herein.

As shown in FIG. 2, the control circuit 116 is coupled to a memory 118 and to a network interface 120 and wireless network(s) 122. The memory 118 can, for example, store non-transitorily computer instructions that cause the control circuit 116 to operate as described herein, when the instructions are executed, as is well known in the art. Further, the network interface 120 may enable the control circuit 116 to communicate with other elements (both internal and external to the system 100). This network interface 120 is well understood in the art. The network interface 120 can communicatively couple the control circuit 116 to the wireless network 122 and whatever other networks 122 may be appropriate for the circumstances. The control circuit 116 may be coupled to or in communication with a server of the merchandise distribution center 102 and may make use of cloud databases and/or operate in conjunction with a cloud computing platform.

Further, it is generally contemplated that the control circuit 116 may be coupled and may access one or more databases. In this particular example, it is coupled to three databases, although one or more of these databases may be combined or additional databases may be accessible. In this example, the control circuit 116 may access a vendor database 124, which may include assignments of the vendors to various priority designations. For instance, the vendor database 124 may include fields showing assignment of the vendors to a high priority group or to a low priority group, and optionally, may further include a medium priority group (or a number of intermediate priority groups). In this example, the control circuit 116 may also access a merchandise database 126, which may include various characteristics of various types of merchandise. For instance, the merchandise database 126 may include fields showing assignment of each type of merchandise to a high priority group or to a low priority group, and it may further include information relating to sales, margins, and/or days on hand of the merchandise item at the merchandise distribution center 102. In this example, the control circuit 116 may also access a purchase order database 128, which may include information relating to current or projected purchase orders. For instance, the purchase order database 128 may include order dates, projected delivery dates to the merchandise distribution center 102, shipment information, etc.

The control circuit 116 receives a merchandise capacity limit for one or more of the storage areas 104 for a future target date at the merchandise distribution center 102 (whether that capacity is based on labor capacity, physical space availability, and/or other factors). The merchandise capacity limit may be calculated in any of various ways. For example, it may be calculated based on the labor or storage capacity of the entire distribution center, of one or more individual storage areas 104 (or chambers), or of some combination thereof. The capacity limit may be calculated by evaluating historical data regarding the distribution center 102 and/or of the individual storage area(s) 104 to determine a maximum capacity. In turn, this maximum capacity may then be adjusted by some predetermined percentage (such as 80% or 90%) to provide a merchandise capacity limit that provides flexible working conditions in the distribution center 102 and storage area(s) 104 and that provides some margin for error. These merchandise capacity limits may be different for each of the storage areas 104 in the merchandise distribution center 102. Each of the storage areas 104 (or chambers) may be designated for certain predetermined types of merchandise items.

The control circuit 116 determines a projected amount of merchandise present at the one or more storage areas 104 for the future target date based, at least in part, on the purchase orders 112. For example, the control circuit 116 may determine the current amount of merchandise present at the storage area(s) 104 for the current date. The control circuit 116 may then extrapolate a projected amount of merchandise for a future date by considering merchandise to be delivered during the intervening time period and merchandise expected to be shipped from the merchandise distribution center 102 (such as to retail stores). The inbound shipments may be determined, in part, from projected delivery dates associated with purchase orders 112. The projected amount of merchandise and the inbound and outbound shipments may also be determined from historical data at the merchandise distribution center 102, such as based on merchandise amounts for that time of year and/or for that day of the week or month.

The control circuit 116 compares the projected amount of merchandise to the merchandise capacity limit for that future target date to determine if an insufficient capacity situation exists. In other words, the control circuit 116 determines if there will be too much merchandise for the capacity of the distribution center 102 or storage area(s) 104. If the projected amount of merchandise does not exceed the merchandise capacity limit, such that no insufficient capacity situation exists for the future target date, then no corrective action needs to be taken. In this circumstance, the control circuit 116 transmits the purchase orders to the corresponding vendors.

If this is not the case, however, then the control circuit 116 adjusts the projected delivery dates of purchase orders 112. In other words, if the projected amount of merchandise exceeds the merchandise capacity limit, such that an insufficient capacity situation exists for the future target date, then the control circuit 116 takes corrective action. Initially, it filters out high priority vendors and high priority types of merchandise (whose projected delivery dates should not be adjusted under any circumstance). It determines a first group of purchase orders 112 corresponding to the high priority set of vendors, determines a second group of purchase orders 112 corresponding to the high priority types of merchandise items, adjusts the projected delivery dates at the merchandise distribution center 102 for at least some of the purchase orders 112 not in the first and second groups to one or more deferred dates after the future target date, and transmits the purchase orders 112 in the first and second groups to the corresponding vendors.

As addressed above, it is contemplated that a filter is initially applied to the purchase orders 112. In other words, some purchase orders 112 have characteristics that make them such a high priority that their projected delivery dates should not be adjusted under any circumstances. The merchandise corresponding to these high priority purchase orders 112 should be delivered to the merchandise distribution center 102 without delay. These purchase orders 112 are therefore filtered out completely from the subsequent prioritization process.

In the form described above, two characteristics of the purchase orders 112 were filtered out: high priority vendors and high priority types of merchandise. It is contemplated that additional characteristics may be used to filter out additional purchase orders 112. For example, promotional types of merchandise may also be filtered out, i.e., merchandise offered in promotional sales. In other words, if the projected amount of merchandise exceeds the merchandise capacity limit, such that an insufficient capacity situation exists on the future target date, the control circuit 116 may be configured to also filter out promotional items. It determines a third group of purchase orders 112 corresponding to promotional types of merchandise items, leaves unchanged the projected delivery dates at the merchandise distribution center 102 for the third group of purchase orders 112, and transmits the purchase orders 112 in the third group to the corresponding vendors.

In addition, or in the alternative, other characteristics may be used to filter out additional purchase orders 112. For example, purchase orders 112 may be filtered out based on merchandise items with low on hand amounts at the distribution center 102. In other words, if the projected amount of merchandise exceeds the merchandise capacity limit, such that an insufficient capacity situation exists, the control circuit 116 may also be configured to filter out merchandise with low on-hand quantities. It determines a fourth group of purchase orders 112 corresponding to types of merchandise items at the merchandise distribution center 102 with on hand amounts below a predetermined minimum threshold, leaves unchanged the projected delivery dates at the merchandise distribution center 102 for the fourth group of purchase orders 112, and transmits the purchase orders 112 in the fourth group to the corresponding vendors.

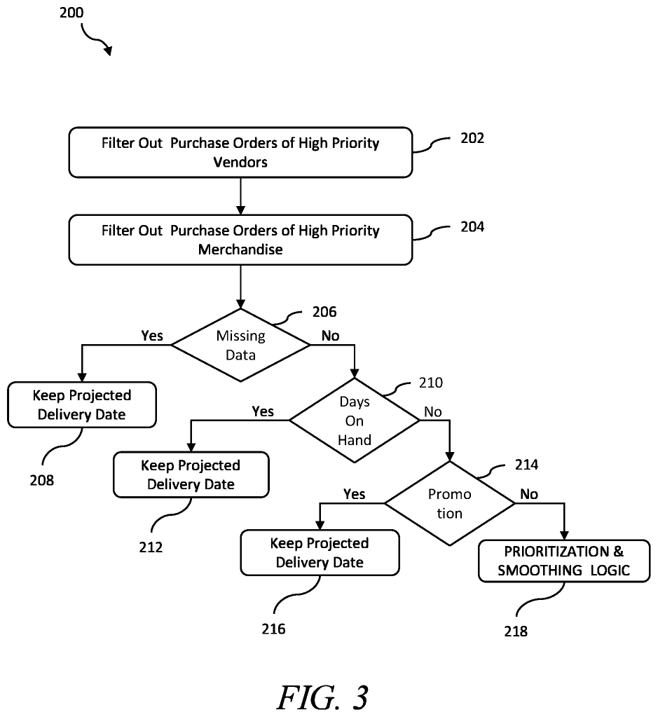

FIG. 3 is a flow diagram showing an example of a filter process 200 that may be applied to the purchase orders 112. At block 202, the purchase orders 112 of high priority vendors is filtered out from prioritization. The vendor priority status may be accessed from a vendor database 124 and may be based on any of various factors, such as, for example, length and/or nature of the relationship with the vendor, reputation, credit rating, financial history, etc. At block 204, the purchase orders 112 of high priority merchandise is filtered out. The priority status may be accessed from a merchandise database 126 and may be based on any of various factors, such as, for example, the perishability of the merchandise.

FIG. 3 then shows three additional criteria that may be used to filter out additional purchase orders 112. In this example, at block 206, there may be missing data relating to a purchase order 112, such as, for example, there may be no forecast data (or other data) for certain merchandise items or some merchandise items may be missing from the merchandise database 126 entirely. At block 208, if certain data is missing, the purchase order 112 keeps its projected delivery date. Then, at block 210, the days on hand (indicating the amount of remaining/forecasted merchandise at the distribution center 102) is considered. For instance, the forecast days on hand may be zero for certain items in the purchase order 112. At block 212, if this amount is below a predetermined minimum, then the purchase order 112 keeps its projected delivery date. Next, at block 214, the merchandise items on the purchase order 112 are considered to determine if any of them are promotional items. At block 216, if there are promotional items, the purchase order 112 keeps its projected delivery date.

If none of these three additional criteria apply to the purchase order, it then moves to block 218. In some forms, one or more of these three filter criteria may be used in the alternative, and in other forms, additional filter criteria may be used. For example, another filter criteria that could be applied would involve filtering out purchase orders 112 containing new types of merchandise items. Block 218 indicates that the purchase order 112 has not been filtered out, and it will therefore be subject to prioritization and smoothing logic (addressed below). In other words, after going through the filter, only the purchase orders remaining proceed to the next step, which is prioritization and smoothing. If a purchase order 112 falls below a certain priority ranking, then its projected delivery date may be moved back to a later date.

Following filtering, this approach may proceed to the prioritization of purchase orders 112 based on specific prioritization rules or logic. In other words, if the projected amount of merchandise exceeds the merchandise capacity limit, such that an insufficient capacity situation exists, the control circuit 116 may be configured to: determine a fifth group of high priority purchase orders 112, as determined by predetermined prioritization rules; leave unchanged the projected delivery dates at the merchandise distribution center 102 for the fifth group of purchase orders 112; and transmit the purchase orders 112 in the fifth group to the corresponding vendors. Conversely, the control circuit 116 determine low priority purchase orders 112 and adjusts their projected delivery dates.

In one form, it is contemplated that the prioritization rules may be based on any one or more of the following variables: forecast sales, lost sales, forecast margin, lost margin, and forecast days on hand of merchandise items at the merchandise distribution center 102. These values may be stored in the merchandise database 126 or may be calculated based on information in the database 126. Forecast sales and forecast margin may be calculated based on the forecast demand data that are stored in merchandise database 126 where the forecast demand is for a certain time period, such as, for example, 14 days. Lost sales and lost margin seek to capture the loss between the time when the item arrives at the distribution center 102 and the time it gets onto a retail store shelf, which may include processing time at the distribution center 102 and shipment to and processing time at a retail store. Days on hand is a determination of how many days the current on hand amount of merchandise will run out if the merchandise in a purchase order 112 does not arrive on a planned date.

In one form, the prioritization rules may calculate a priority score that includes all of these factors: forecast sales, lost sales, forecast margin, lost margin, and forecast days on hand. For example, the prioritization rules may be based on a priority score calculation for each purchase order in the fifth group of purchase orders, where the priority score calculation is based on combining a priority value for each of: total forecast sales for the merchandise items in the purchase order, total lost sales for the merchandise items in the purchase order, total forecast margins for the merchandise items in the purchase order, total lost margins for the merchandise items in the purchase order, and a forecast days on hand for the merchandise item in the purchase order with the minimum forecast days on hand. It should be understood that this priority score for the purchase orders 112 may be calculated either before or after filtering, but the actual prioritization and adjustment (or smoothing) of projected delivery dates occurs after filtering.

An example of a prioritization approach is now described in more detail. Under this approach, for each purchase order 112, five metrics (forecast sales, lost sales, forecast margin, lost margin and forecast days on hand) are first calculated at the merchandise item level. Then, those values are summed to get the first four metrics at the purchase order level, and forecast days on hand is calculated by taking the minimum of all items in the purchase order 112. Then, the purchase orders 112 are sorted based on each metric. The priority score for each purchase order 112 is calculated by summing up all five rankings. The following paragraphs explain the calculations in more detail.

Forecast sales and forecast margin are calculated based on forecast demand data stored in the merchandise database 126. The database 126 contains the forecast demand for the next 14 days by merchandise item for the distribution center 102. With this data, forecast sales and forecast margin are calculated using Equation 1 and Equation 2 below. In these two equations, i equals 14 for most of the cases. For those items that do not have the data for 14 days, this approach uses the average demand value times 14 in the calculation.

Forecast Sales=Price×ΣForecast Demand on Day i, for all i (1)

Forecast Margin=(Price−Cost)×ΣForecast Demand on Day i, for all i (2)

Example Calculation

TABLE 1
Item information for forecast sales and forecast margin calculation

| | Base Unit Retail | Vendor Pack Cost | Vendor Pack |
|---|---|---|---|
| MDS FAM ID | Amount | Amount | Quantity |
| 92202972 | 4.87 | 25.1 | 10 |

TABLE 2
Forecast demand for forecast sales and forecast margin calculation

| | | Forecast Demand |
|---|---|---|
| Item Number | Forecast Date | Each Quantity |
| 92202972 | Feb. 28, 2018 | 140 |
| 92202972 | Mar. 1, 2018 | 114.62 |
| 92202972 | Mar. 2, 2018 | 43.37 |
| 92202972 | Mar. 3, 2018 | 90 |
| 92202972 | Mar. 4, 2018 | 140 |
| 92202972 | Mar. 5, 2018 | 90 |
| 92202972 | Mar. 6, 2018 | 140 |
| 92202972 | Mar. 7, 2018 | 160 |
| 92202972 | Mar. 8, 2018 | 140 |
| 92202972 | Mar. 9, 2018 | 150 |
| 92202972 | Mar. 10, 2018 | 70 |
| 92202972 | Mar. 11, 2018 | 170 |
| 92202972 | Mar. 12, 2018 | 120 |
| 92202972 | Mar. 13, 2018 | 90 |

Using the values in Tables 1 and 2, forecast sales and forecast margin for item 92202972 can be calculated as below:

Forecast Sales=(140+114.62+43.37+90+140+90+140+160+140+150+70+170+120+90)×4.87=8074.41

Forecast Margin=(140+114.62+43.37+90+140+90+140+160+140+150+70+170+120+90)×(4.87−25.1/10)=3912.86

Lost sales and lost margin captures the loss between the time when the item arrives in the distribution center 102 and the time it gets onto a retail store shelf. This approach assumes it takes two days to process the item before it gets into the distribution center 102. Therefore, the purchase order in distribution center date equals the projected delivery date plus two. Also, this approach assumes it takes two days to ship the item to a store and one more day to process the item at the store. So, lost sales and lost margin are calculated for the three days after the item gets in the distribution center 102 using Equation 3 and Equation 4 below. The forecast on hand used in this calculation is also from the merchandise database 126. If there is no forecast on hand for certain days, this approach uses the average.

$$Lost Sales = {{Price \times \sum Min}^{PO in DC date + 2}}_{i = PO in DC date} ( 0 , Forecast On Hand on Day i ) \times ( - 1 ) \qquad ( 3 )$$

$$Lost Margin = {{Margin \times \sum Min}^{PO in DC date + 2}}_{i = PO in DC date} ( 0 , Forecast On Hand on Day i ) \times ( - 1 ) \qquad ( 4 )$$

In the equations, PO stands for purchase order and DC stands for distribution center.

Example Calculation

TABLE 3
Purchase order information for lost
sales and lost margin calculation

| Order Group ID | MDS FAM ID | Proj. Delivery Date | Order Date |
|---|---|---|---|
| 613637628 | 92202972 | Mar. 11, 2018 | Feb. 28, 2018 |

TABLE 4
Item information for lost sales and lost margin calculation

| | Base Unit Retail | Vendor Pack Cost | Vendor Pack |
|---|---|---|---|
| MDS FAM ID | Amount | Amount | Quantity |
| 92202972 | 4.87 | 25.1 | 10 |

TABLE 5
Forecast data for lost sales and lost margin calculation

| | | Forecast Demand | Forecast On Hand |
|---|---|---|---|
| Item Number | Forecast Date | Each Quantity | Quantity |
| 92202972 | Mar. 8, 2018 | 140 | 312.01 |
| 92202972 | Mar. 9, 2018 | 150 | 172.01 |
| 92202972 | Mar. 10, 2018 | 70 | 22.01 |
| 92202972 | Mar. 11, 2018 | 170 | −27.99 |
| 92202972 | Mar. 12, 2018 | 120 | −197.99 |
| 92202972 | Mar. 13, 2018 | 90 | 52.01 |

The projected delivery date for this purchase order is Mar. 11, 2018, and based on the assumption of two days of distribution center processing, the purchase order in distribution center date is Mar. 13, 2018. Using the values in the above three tables, the lost sales and forecast margin for merchandise item 92202972 can be calculated as below:

$$Average On hand = - 12 \text{.32}$$

$$Base Unit Margin = 2.36$$

$$Lost Sales = 4.87 \times Min ( 0 , 52.01 - 90 ) \times ( - 1 ) + 4.87 \times Min ( 0 , - 12.32 ) \times ( - 1 ) + 4.87 \times Min ( 0 , - 12.32 ) \times ( - 1 ) = 4.87 \times ( 37.99 + 12.32 + 12.32 ) = 305 \text{.01}$$

$$Lost Margin = 2.36 \times Min ( 0 , 52.01 - 90 ) \times ( - 1 ) + 2.36 \times Min ( 0 , - 12.32 ) \times ( - 1 ) + 2.36 \times Min ( 0 , - 12.32 ) \times ( - 1 ) = 2.36 \times ( 37.99 + 12.32 + 12.32 ) = 147.81$$

The days on hand amount is a determination of when the current on hand amount will run out if the merchandise in a purchase order does not arrive on a planned date. When doing the calculation, this approach first finds the purchase order in distribution center date and gets the forecast on hand for that day. Then, this approach subtracts the forecast demand for that day and forward, and counts the number of days before the merchandise on hand rans out. If there is no forecast data for certain days, this approach uses the average value.

Example Calculation

TABLE 6
Purchase order information for days on hand calculation

| Order Group ID | MDS FAM ID | Proj. Delivery Date | Order Date |
|---|---|---|---|
| 613637628 | 92202972 | Mar. 11, 2018 | Feb. 28, 2018 |

TABLE 7
Forecast data for days on hand calculation

| | | Forecast Demand | Forecast On Hand |
|---|---|---|---|
| Item Number | Forecast Date | Each Quantity | Quantity |
| 92202972 | Mar. 8, 2018 | 140 | 312.01 |
| 92202972 | Mar. 9, 2018 | 150 | 172.01 |
| 92202972 | Mar. 10, 2018 | 70 | 22.01 |
| 92202972 | Mar. 11, 2018 | 170 | −27.99 |
| 92202972 | Mar. 12, 2018 | 120 | −197.99 |
| 92202972 | Mar. 13, 2018 | 90 | 52.01 |

The projected delivery date for this purchase order is Mar. 18, 2011, and the purchase order in distribution center date is Mar. 13, 2018 based on the assumption of two days processing at the distribution center 102. The forecast on hand at the beginning of that day is 52.01. By subtracting the forecasted demand, the approach gets the following on hand at the end of that day (52.01−90=−37.99), which is less than 0. Therefore, the forecast days on hand for this example will be 0.

After calculating the five metrics for all merchandise items in each purchase order, the same metrics will also be calculated at a purchase order level. Forecast sales, lost sales, forecast margin, and lost margin are calculated by summing up all item level values, while the days on hand is calculated by taking the minimum days on hand among all items. Table 8 shows a calculation example for a purchase order (Order Group ID 665058154) that contains four items in it.

TABLE 8
Metric calculation at purchase order level

| Item | MDS FAM | Forecast | Lost | Forecast | Lost | Days On |
|---|---|---|---|---|---|---|
| Number | ID | Sales | Sales | Margin | Margin | Hand |
| 9296326 | 40435492 | 14192.64 | 0 | 5645.64 | 0 | 2 |
| 9296333 | 40435499 | 37401.60 | 0 | 14877.85 | 0 | 4 |
| 9296354 | 40435559 | 48522.24 | 0 | 18985.59 | 0 | 3 |
| 9297436 | 51034441 | 16665.60 | 0 | 5685.40 | 0 | 4 |

| | | | | | |
|---|---|---|---|---|---|
| Order Group ID 665058154 | 116782.10 | 0 | 45194.48 | 0 | 2 |

After finishing the metric calculation for all purchase orders, priority scores are calculated based on a ranking algorithm. When selecting the purchase that needs to be pushed out, decisions are made based on the relative priority order of a purchase order among all purchase orders that have the same storage area and projected delivery date. Therefore, the priority score and priority rank are both relative values that are calculated among purchase orders that have the same storage area and projected delivery date.

Table 9 shows the metric values for all purchase orders for a storage area that were ordered on Aug. 19, 2018, and all these purchase orders have projected delivery dates on Aug. 28, 3018. The approach then sort those purchases orders to obtain the associated priority ranks. For each purchase order, adding up all five ranks will give its priority score. Table 10 shows the rank of each metric, the priority score, and the priority rank for the purchase orders shown in Table 9.

TABLE 9
Purchase order level metric values

| Order | Load Group | Forecast | Lost | Forecast | Lost | Days On |
|---|---|---|---|---|---|---|
| Group ID | ID | Sales | Sales | Margin | Margin | Hand |
| 665058306 | 85750732 | 172474.8 | 902.88 | 97587.95 | 136.8 | 0 |
| 665058154 | 85749969 | 116782.1 | 0 | 45194.48 | 0 | 2 |
| 665050936 | 85758300 | 56130.72 | 0 | 24476.55 | 0 | 3 |
| 665050938 | 85758302 | 32791.36 | 0 | 16462.76 | 0 | 3 |
| 665058168 | 85749969 | 32407.56 | 0 | 14089.76 | 0 | 3 |
| 665059478 | 85750687 | 38892 | 0 | 14130.76 | 0 | 7 |
| 665057775 | 85750732 | 23959.2 | 0 | 9246 | 0 | 6 |
| 665057800 | 85750139 | 2138.4 | 0 | 540 | 0 | 15 |

TABLE 10
Priority score and priority rank calculation

| Order | Load | Forecast | Lost | Forecast | Lost | Days On | Priority | Priority |
|---|---|---|---|---|---|---|---|---|
| Group ID | Group ID | Sales Rank | Sales Rank | Margin Rank | Margin Rank | Hand Rank | Score | Rank |
| 665058306 | 85750732 | 1 | 1 | 1 | 1 | 1 | 5 | 1 |
| 665058154 | 85749969 | 2 | 2 | 2 | 2 | 2 | 10 | 2 |
| 665050936 | 85758300 | 3 | 2 | 3 | 2 | 3 | 13 | 3 |
| 665050938 | 85758302 | 5 | 2 | 4 | 2 | 3 | 16 | 4 |
| 665058168 | 85749969 | 6 | 2 | 6 | 2 | 3 | 19 | 5 |
| 665059478 | 85750687 | 4 | 2 | 5 | 2 | 7 | 20 | 6 |
| 665057775 | 85750732 | 7 | 2 | 7 | 2 | 6 | 24 | 7 |
| 665057800 | 85750139 | 8 | 2 | 8 | 2 | 8 | 28 | 8 |

Filtering and prioritization, however, may lead to different results where there are multiple purchase orders 112 for the same load group, such as a load delivered by a delivery vehicle. Filtering may require that the projected delivery date for one of the purchase orders 112 on the delivery vehicle be left unchanged and not be adjusted. In contrast, prioritization may require that the projected delivery date for a different one of the purchase orders be adjusted. So, these different requirements may need to be reconciled in some manner.

In one form, all of the purchase orders 112 in a delivery load may remain unchanged (no adjustment of projected delivery date) if one of the items is a high priority item. In other words, if one of the purchase orders 112 is filtered out, this filtering may be applied to the remaining purchase orders 112 on the vehicle, i.e., to the entire delivery load or load group. In this circumstance, if the projected amount of merchandise exceeds the merchandise capacity limit, such that an insufficient capacity situation exists, the control circuit 116 may be configured to: receive delivery load information corresponding to a merchandise load to be delivered by a delivery vehicle in which each delivery load includes merchandise in one or more purchase orders 112; determine a high priority delivery load that includes a purchase order 112 that has been prioritized as a high priority purchase order 112 with a projected delivery date that is not to be deferred; identify other purchase orders in the high priority delivery load; and leave unchanged the projected delivery dates of the other purchase orders 112 in the high priority delivery load.

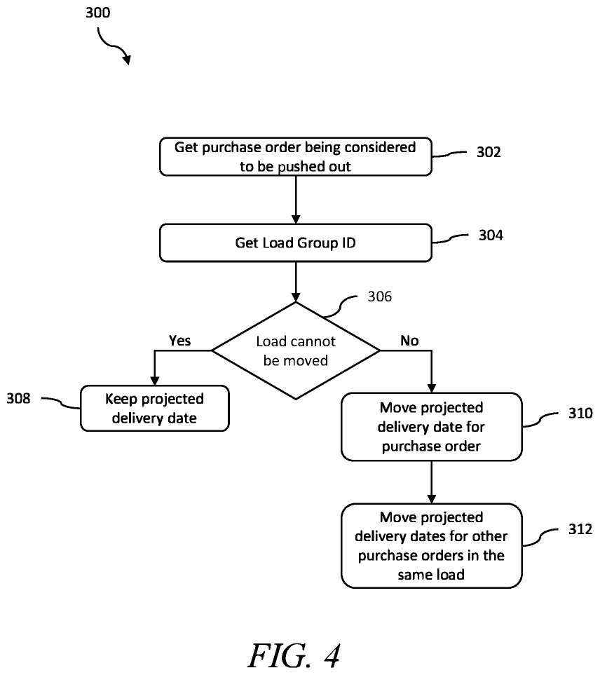

FIG. 4 is a flow diagram showing an example of a process 300 where projected delivery dates are not adjusted where the delivery vehicle/trailer includes a purchase order 112 that has been filtered. At block 302, after comparing the incoming volume with the distribution center capacity, a purchase order 112 is considered for adjustment (preferably purchase orders 112 are considered moving from the lowest priority score to the highest priority score). At block 304, if a purchase order 112 needs to be deferred (pushed out), the approach accesses the load group ID of the purchase order 112, and at block 306, it checks if the load group contains any purchase orders 112 that cannot be moved. In other words, it checks to see if any of the purchase orders 112 have been filtered based on criteria, such as, without limitation, missing data, days on hand of merchandise, promotional items, etc., as addressed above. If yes, at block 308, this approach keeps the original projected delivery date for this purchase order 112 and moves to the next purchase order 112 that has a higher priority. If no, at block 310, this approach moves this purchase order 112 and, at block 312, it also moves the other purchase orders 112 on the same load.

Optionally, in another form, all of the purchase orders 112 in a delivery load might receive the same adjusted projected delivery date if all of the items are determined to be low priority items. In other words, the same projected delivery date might be selected for all of the purchase orders 112 on a low priority delivery load, such as, for example, the earliest projected delivery date of all the purchase orders or the latest projected delivery date. In this circumstance, if the projected amount of merchandise exceeds the merchandise capacity limit, such that an insufficient capacity situation exists, the control circuit 116 may be configured to: determine a low priority delivery load where none of the purchase orders 112 in the load have been prioritized as a high priority purchase order such that the projected delivery dates of all of the purchase orders 112 may be deferred; and adjust the projected delivery dates of all of the purchase orders 112 to the same projected delivery date.

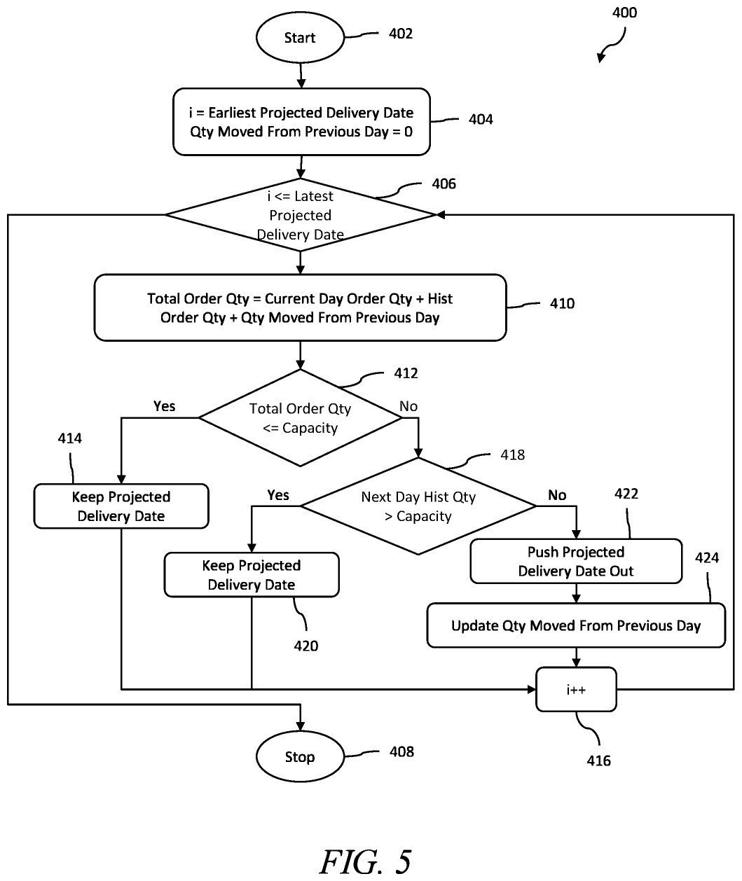

FIG. 5 is a flow diagram showing an example of a date adjustment (or “smoothing”) process 400. Following purchase order filtering and prioritization, this approach determines whether a projected delivery date of a purchase order should be pushed back (or deferred). The projected delivery date should be moved back to a date where there is sufficient capacity at the merchandise distribution center 102. In other words, the approach seeks to avoid adjusting a purchase order 112 from a date where there is insufficient capacity to a later date where there is still insufficient capacity. This part of the approach involving automatic adjustment of a projected delivery date seeks to “smooth” out the merchandise being handled at the distribution center 102 over time.

The general idea for smoothing is to move purchase orders 112 to the next day, if needed, based on capacity at the merchandise distribution center 102. In one form, the smoothing process is conducted by projected delivery date from the earliest to the latest for purchase orders ordered on the same day and including merchandise intended for the same chamber/storage area 104. The iteration preferably starts from the earliest projected delivery date and ends after finishing the latest projected delivery date.

In FIG. 5, at blocks 402, 404, 406, and 408, the process 400 starts at the earliest projected delivery date and proceeds day by day until it stops at the last projected delivery date. At block 410, for each projected delivery date, the approach first calculates the total purchase order quantity that will arrive on the projected delivery date, which includes the current day order quantity plus the historical order quantity and any quantity moved from a previous day. At block 412, for that projected delivery date, it compares this total order quantity with the distribution center capacity. At block 414, if the demand is less than capacity, then the approach keeps the original projected delivery date and, at block 416, the approach proceeds to the next iteration. Otherwise, at block 418, it will compare the next day's historical quantity with the distribution center capacity. In other words, this approach checks to see if the next day has any spaces to take additional purchase orders. At block 420, if the next day historical quantity exceeds capacity, then it will keep the original projected delivery date and go to next iteration at block 416. However, at block 422, if the next day historical quantity does not exceed capacity, it will adjust the projected delivery date to the next day, and at block 424, the approach updates the quantity moved from the previous day.

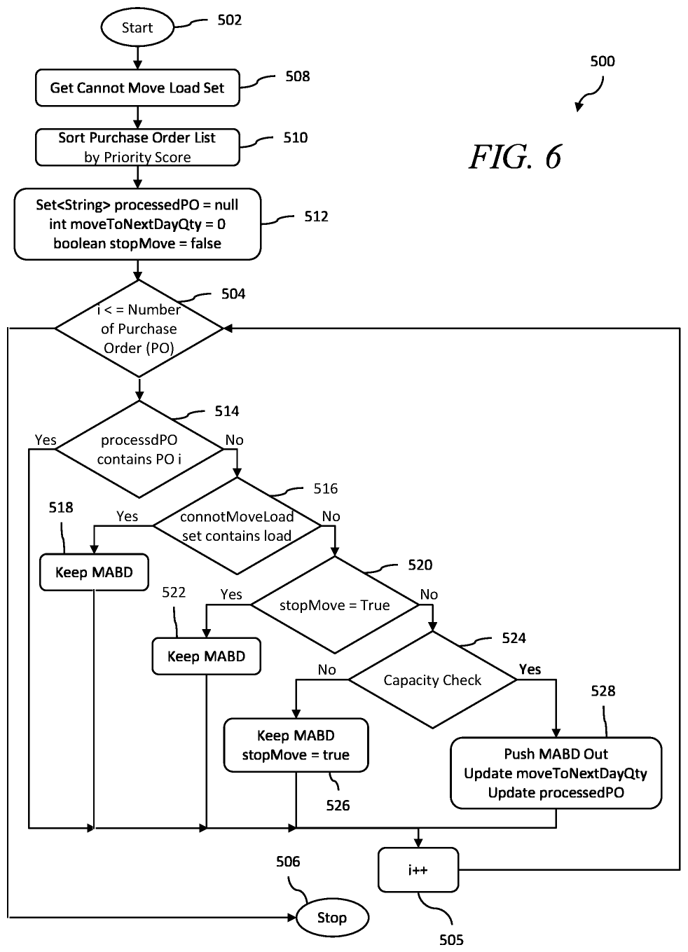

FIG. 6 is a flow diagram showing another example of a smoothing process 500 for pushing out (deferring) purchase orders and showing filtering and prioritization considerations. At blocks 502, 504, 505, and 506, the process 500 starts with a first purchase order and proceeds one by one until all of the purchase orders have been considered. At block 508, the “cannot move” load set has to be identified, i.e., the filtered purchase orders must be identified. An example of a “cannot move” load set is shown in FIG. 4 and was described above. Then, at block 510, the purchase order list is sorted by priority score, and examples of priority score calculations were described above. At block 504, the iteration is started from the purchase order with lowest priority incrementally to the purchase order with the highest priority. At block 512, certain variables are set to initial values.

At block 514, the process 500 considers if the purchase order has already been processed, which may occur if the purchase order is part of the “cannot move” load set. For example, the purchase order may be part of a trailer/shipment that has been designated as cannot be moved because of another (high priority) purchase order in that load group/trailer/shipment. In this circumstance, if the purchase order has already been processed with other purchase orders in the same load, then the approach will proceed to the next purchase order.

At block 516, if the purchase order was not previously processed, a determination will then be made if it is in the “cannot move” load set. At block 518, if it is in a load that contains some purchase orders that cannot be moved, the process 500 will keep the original projected delivery date, or must-arrive-by-date (MABD), for this purchase order. If not, the process 500 will move on to block 520.

At block 520, this approach checks to see if the stop indicator has been turned on (boolean variable stopMove equals true). If the stop indicator has been turned on, this indicates that enough purchase orders have already been pushed out or that there is no more space on the next day. At block 522, if the stop indicator has been turned on, the process 500 keeps the original projected delivery date, or must-arrive-by-date (MABD), for the current purchase order. If the stop indicator has not been turned on, the process 500 advances to block 524.

At block 524, a capacity check is performed. At block 524, in the current iteration, the process 500 determines if the volume on the current projected delivery date is still over capacity, given that some purchase orders may already have been pushed out in previous iterations. It will also determine whether pushing the purchase order and the other purchase orders in the same load to the next day will exceed the distribution center capacity. At block 526, if the current date is now under capacity or if the next date is over capacity, then the process 500 keeps the projected delivery date, or must-arrive-by-date (MABD), and turns on the stop indicator. If not, at block 528, the process 500 sets the new projected delivery date, or must-arrive-by-date (MABD), for all purchase orders in the same load, updates the quantity moved to next day, and updates the processed purchase order set.

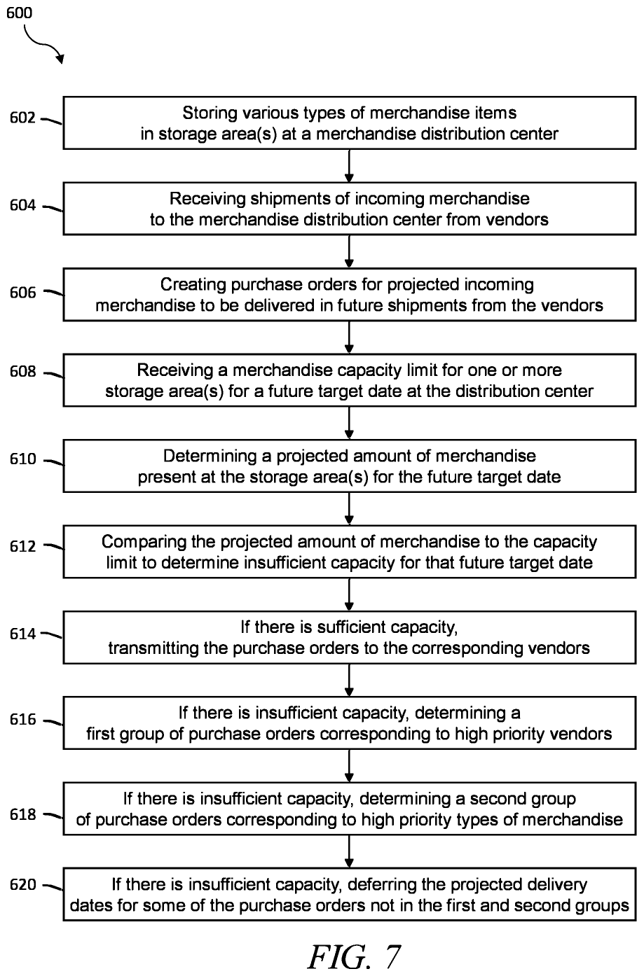

Referring to FIG. 7, there is shown a process 600 for regulating the amount of merchandise received at merchandise distribution centers. This process 600 may incorporate one or more of the elements described above in system 100. Further, this process 600 summarizes and incorporates the processes 300, 400, and 500 described above. As should be understood, these steps do not necessarily occur in the specific order in which they are presented.

At block 602, various types of merchandise items are stored in one or more storage areas/chambers at a merchandise distribution center. At block 604, shipments of incoming merchandise from vendors are received at the merchandise distribution center. In one form, it is generally contemplated that merchandise center stores merchandise, receives inbound shipments of merchandise from vendors, and sends outbound shipments of merchandise to retail stores.

At block 606, purchase orders are created for projected incoming merchandise to be delivered in future shipments from the vendors. These purchase orders initially include projected delivery dates (or must-arrive-by-dates) indicating when the deliveries must arrive at the merchandise distribution center. These purchase orders, however, are considered for adjustment (or deferral) of the projected delivery dates prior to being sent out to the vendors.

At block 608, a merchandise capacity limit is received for the distribution center or for one or more storage area(s) for a future target date at the distribution center (whether that capacity is based on labor capacity, physical space availability, and/or other factors). At block 610, a projected amount of merchandise is determined as expected to be present at the storage area(s) for the future target date. At block 612, the projected amount of merchandise is compared to the capacity limit to determine insufficient capacity for that future target date.

At block 614, there is sufficient capacity for the future target date. In other words, there is enough capacity at the merchandise distribution center to handle the projected amount of merchandise for the future target date. In this circumstance, the purchase orders are transmitted to the corresponding vendors (without adjustment of the projected delivery dates).

At blocks 616, 618, and 620, there is insufficient capacity for the future target date. At block 616, a first group of purchase orders corresponding to high priority vendors is determined. At block 618, a second group of purchase orders corresponding to high priority types of merchandise is determined. At block 620, the projected delivery dates for some of the purchase orders not in the first and second groups are deferred. In other words, the projected delivery dates at the merchandise distribution center are adjusted, for at least some of the purchase orders not in the first and second groups, to one or more deferred dates after the future target date, and the purchase orders in the first and second groups are transmitted to the corresponding vendors.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for regulating the amount of merchandise received at merchandise distribution centers, the system comprising:
a merchandise distribution center configured for storage of a plurality of types of merchandise items in a plurality of storage areas, the merchandise distribution center comprising one or more receiving areas configured to receive delivery vehicles with incoming merchandise for unloading and storage at the merchandise distribution center;
the plurality of types of merchandise items comprising a first set of high priority types of merchandise items and a second set of low priority types of merchandise items;
a plurality of purchase orders for projected incoming merchandise to be delivered in future shipments from a plurality of vendors supplying shipments of the incoming merchandise to the merchandise distribution center, the plurality of vendors comprising a first set of high priority vendors and a second set of low priority vendors;
each purchase order including one or more types of merchandise items with a projected delivery date at the merchandise distribution center;
a control circuit configured to:
receive a merchandise capacity limit for one or more of the storage areas for a future target date at the merchandise distribution center;
determine a projected amount of merchandise present at the one or more storage areas for the future target date based, at least in part, on the plurality of purchase orders;
compare the projected amount of merchandise to the merchandise capacity limit to determine an insufficient capacity situation for that future target date;
if the projected amount of merchandise does not exceed the merchandise capacity limit, such that no insufficient capacity situation exists for the future target date:
transmit the plurality of purchase orders to the corresponding vendors;
if the projected amount of merchandise exceeds the merchandise capacity limit, such that an insufficient capacity situation exists for the future target date:
determine a first group of purchase orders corresponding to the high priority set of vendors;
determine a second group of purchase orders corresponding to the high priority types of merchandise items;
adjust the projected delivery dates at the merchandise distribution center for at least some of the purchase orders not in the first and second groups to one or more deferred dates after the future target date; and
transmit the purchase orders in the first and second groups to the corresponding vendors.

2. The system of claim 1, wherein the first set of high priority types of merchandise items comprises at least one of meat, produce, and other types of perishable merchandise items.

3. The system of claim 1, wherein, if the projected amount of merchandise exceeds the merchandise capacity limit, such that an insufficient capacity situation exists on the future target date, the control circuit is configured to:
determine a third group of purchase orders corresponding to promotional types of merchandise items;
leave unchanged the projected delivery dates at the merchandise distribution center for the third group of purchase orders; and
transmit the purchase orders in the third group to the corresponding vendors.

4. The system of claim 1, wherein, if the projected amount of merchandise exceeds the merchandise capacity limit, such that an insufficient capacity situation exists, the control circuit is configured to:
determine a fourth group of purchase orders corresponding to types of merchandise items at the merchandise distribution center with on hand amounts below a predetermined minimum threshold;
leave unchanged the projected delivery dates at the merchandise distribution center for the fourth group of purchase orders; and
transmit the purchase orders in the fourth group to the corresponding vendors.

5. The system of claim 1, wherein, if the projected amount of merchandise exceeds the merchandise capacity limit, such that an insufficient capacity situation exists, the control circuit is configured to:
determine a fifth group of high priority purchase orders, as determined by predetermined prioritization rules;
leave unchanged the projected delivery dates at the merchandise distribution center for the fifth group of purchase orders; and
transmit the purchase orders in the fifth group to the corresponding vendors.

6. The system of claim 5, wherein the prioritization rules are based on one or more of forecast sales, lost sales, forecast margin, lost margin, and forecast days on hand of merchandise items at the merchandise distribution center.

7. The system of claim 6, wherein the prioritization rules are based on a priority score calculation for each purchase order in the fifth group of purchase orders, the priority score calculation based on combining a priority value for each of: total forecast sales for the merchandise items in the purchase order, total lost sales for the merchandise items in the purchase order, total forecast margins for the merchandise items in the purchase order, total lost margins for the merchandise items in the purchase order, and a forecast days on hand for the merchandise item in the purchase order with the minimum forecast days on hand.

8. The system of claim 1, wherein, if the projected amount of merchandise exceeds the merchandise capacity limit, such that an insufficient capacity situation exists, the control circuit is configured to:
receive delivery load information corresponding to a merchandise load to be delivered by a delivery vehicle, each delivery load including merchandise in one or more purchase orders;
determine a high priority delivery load that includes a purchase order that has been prioritized as a high priority purchase order with a projected delivery date that is not to be deferred;
identify other purchase orders in the high priority delivery load; and
leave unchanged the projected delivery dates of the other purchase orders in the high priority delivery load.

9. The system of claim 8, wherein, if the projected amount of merchandise exceeds the merchandise capacity limit, such that an insufficient capacity situation exists, the control circuit is configured to:
determine a low priority delivery load where none of the purchase orders in the load have been prioritized as a high priority purchase order such that the projected delivery dates of all of the purchase orders may be deferred; and
adjust the projected delivery dates of all of the purchase orders to the same projected delivery date.

10. The system of claim 1, wherein each projected delivery date is determined by lead time required for each vendor and comprises order processing time and delivery transit time to the merchandise distribution center.

11. The system of claim 1, wherein the merchandise capacity limit is determined, at least in part, by labor capacity, the labor capacity used to calculate a maximum number of merchandise cases that can be handled by individuals at the merchandise distribution center.

12. A method for regulating the amount of merchandise received at merchandise distribution centers, the method comprising:
storing a plurality of types of merchandise items in a plurality of storage areas at a merchandise distribution center, the merchandise distribution center comprising one or more receiving areas configured to receive delivery vehicles with incoming merchandise for unloading and storage at the merchandise distribution center;
the plurality of types of merchandise items comprising a first set of high priority types of merchandise items and a second set of low priority types of merchandise items;
receiving shipments of the incoming merchandise to the merchandise distribution center from a plurality of vendors, the plurality of vendors comprising a first set of high priority vendors and a second set of low priority vendors;
creating a plurality of purchase orders for projected incoming merchandise to be delivered in future shipments from the plurality of vendors, each purchase order including one or more types of merchandise items with a projected delivery date at the merchandise distribution center;
by a control circuit:
receiving a merchandise capacity limit for one or more of the storage areas for a future target date at the merchandise distribution center;
determining a projected amount of merchandise present at the one or more storage areas for the future target date based, at least in part, on the plurality of purchase orders;
comparing the projected amount of merchandise to the merchandise capacity limit and determining that an insufficient capacity situation exists for that future target date; and
based on the comparison:
determining a first group of purchase orders corresponding to the high priority set of vendors;
determining a second group of purchase orders corresponding to the high priority types of merchandise items;
adjusting the projected delivery dates at the merchandise distribution center for at least some of the purchase orders not in the first and second groups to one or more deferred dates after the future target date; and
transmitting the purchase orders in the first and second groups to the corresponding vendors.

13. The method of claim 12, wherein the first set of high priority types of merchandise items comprises at least one of meat, produce, and other types of perishable merchandise items.

14. The method of claim 12, further comprising, based on the comparison, by the control circuit:
determining a third group of purchase orders corresponding to promotional types of merchandise items;
leaving unchanged the projected delivery dates at the merchandise distribution center for the third group of purchase orders; and
transmitting the purchase orders in the third group to the corresponding vendors.

15. The method of claim 12, further comprising, based on the comparison, by the control circuit:
determining a fourth group of purchase orders corresponding to types of merchandise items at the merchandise distribution center with on hand amounts below a predetermined minimum threshold;
leaving unchanged the projected delivery dates at the merchandise distribution center for the fourth group of purchase orders; and
transmitting the purchase orders in the fourth group to the corresponding vendors.

16. The method of claim 12, further comprising, based on the comparison, by the control circuit:
determining a fifth group of high priority purchase orders, as determined by predetermined prioritization rules;
leaving unchanged the projected delivery dates at the merchandise distribution center for the fifth group of purchase orders; and
transmitting the purchase orders in the fifth group to the corresponding vendors.

17. The method of claim 16, wherein the prioritization rules are based on one or more of forecast sales, lost sales, forecast margin, lost margin, and forecast days on hand of merchandise items at the merchandise distribution center.

18. The method of claim 17, wherein the prioritization rules are based on a priority score calculation for each purchase order in the fifth group of purchase orders, the priority score calculation based on combining a priority value for each of: total forecast sales for the merchandise items in the purchase order, total lost sales for the merchandise items in the purchase order, total forecast margins for the merchandise items in the purchase order, total lost margins for the merchandise items in the purchase order, and a forecast days on hand for the merchandise item in the purchase order with the minimum forecast days on hand.

19. The method of claim 12, further comprising, based on the comparison, by the control circuit:
receiving delivery load information corresponding to a merchandise load to be delivered by a delivery vehicle, each delivery load including merchandise in one or more purchase orders;
determining a high priority delivery load that includes a purchase order that has been prioritized as a high priority purchase order with a projected delivery date that is not to be deferred;
identifying other purchase orders in the high priority delivery load; and
leaving unchanged the projected delivery dates of the other purchase orders in the high priority delivery load.

20. The method of claim 19, further comprising, based on the comparison, by the control circuit:
determining a low priority delivery load where none of the purchase orders in the load have been prioritized as a high priority purchase order such that the projected delivery dates of all of the purchase orders may be deferred; and
adjusting the projected delivery dates of all of the purchase orders to the same projected delivery date.

21. The method of claim 12, wherein each projected delivery date is determined by lead time required for each vendor and comprises order processing time and delivery transit time to the merchandise distribution center.
